(19) United States
(12) Patent Application Publication
(10) Pub. No.: US 2005/0023368 A1
(43) Pub. Date: Feb. 3, 2005

(54) Method of designing improved spray dispenser assemblies

(75) Inventors: Richard S. Valpey III, Lindenhurst, IL (US); John F. Goelz, Racine, WI (US); Michael J. Rohrer, Oak Creek, WI (US)

Correspondence Address: S.C. JOHNSON & SON, INC., 1525 HOWE STREET, RACINE, WI, 53403-2236, US

(73) Assignee: S.C. Johnson & Son, Inc., Racine, WI (US)

(21) Appl. No.: 10/896,897

(22) Filed: Jul. 23, 2004

Related U.S. Application Data
(63) Continuation-in-part of application No. 10/653,211, filed on Sep. 3, 2003.
Application No. 10/653,211 is a continuation-in-part of application No. 10/350,011, filed on Jan. 24, 2003, now Pat. No. 6,824,079.

(51) Int. Cl. B05D 1/00; B05B 17/00

(52) U.S. Cl. 239/1; 239/11; 239/7

(57) ABSTRACT

A method of determining design parameters for a design of a spray dispenser assembly for dispensing a mist. The method includes identifying one or more preferred performance characteristics of the spray dispenser to be designed and identifying design variables of structures of a spray dispenser assembly that affect those performance characteristics. The method also includes obtaining test data indicative of performance characteristics of spray dispensers at different combinations of values of the design variables. To achieve an improved dispenser design, design parameters are defined for the identified design variables based on the test data. The design parameters provide the preferred performance characteristics when embodied in a spray dispenser.

This application is a continuation-in-part of copending U.S. patent application Ser. No. 10/653,211, filed on Sep. 3, 2003. That application is a continuation-in-part of copending U.S. patent application Ser. No.10/350,011, which was filed on Jan. 24, 2003.

### FIELD OF THE INVENTION

Our invention relates generally to the field of spray dispenser assemblies and methods of designing the same. In particular, our invention relates to the field of designing aerosol dispenser assemblies using a liquefied gas propellant to expel a liquid product from a container. However, while the specific examples discussed herein focus on aerosol spray assemblies, our design method may also be employed to design other spray dispensers, such as those operated by pump action.

### BACKGROUND OF THE INVENTION

Aerosol dispensers have been commonly used to dispense personal, household, industrial, and medical products, and provide a low cost, easy to use method of dispensing such products. Typically, aerosol dispensers include a container, which contains a liquid product to be dispensed, such as soap, insecticide, paint, deodorant, disinfectant, air freshener, or the like. A propellant is used to discharge the liquid product from the container. The propellant is pressurized and provides a force to expel the liquid product from the container when a user actuates the aerosol dispenser by, for example, pressing an actuator button.

The two main types of propellants used in aerosol dispensers today are liquefied gas propellants, such as hydrocarbon and hydrofluorocarbon (HFC) propellants, and compressed gas propellants, such as compressed carbon dioxide or nitrogen gas. To a lesser extent, chlorofluorocarbon propellants (CFCs) are also used. The use of CFCs is, however, being phased out due to the potentially harmful effects of CFCs on the environment.

In an aerosol dispenser using the liquefied gas-type propellant, the container is loaded with the liquid product and propellant to a pressure approximately equal to, or slightly greater than, the vapor pressure of the propellant. Thus filled, the container still has a certain amount of space that is not occupied by liquid. This space is referred to as the “head space” of the dispenser assembly. Since the container is pressurized to approximately the vapor pressure of the propellant, some of the propellant is dissolved or emulsified in the liquid product. The remainder of the propellant is in the vapor phase and fills the head space. As the product is dispensed, the pressure in the container remains approximately constant as liquid propellant evaporates to replenish discharged vapor. In contrast, compressed gas propellants are present entirely in the vapor phase. That is, no portion of a compressed gas propellant is in the liquid phase. As a result, the pressure within a compressed gas aerosol dispenser assembly decreases as the vapor is dispensed.

A conventional aerosol dispenser is illustrated in FIG. 3, and generally comprises a container (not shown) for holding a liquid product and a propellant, and a valve assembly for selectively dispensing a liquid product from the container. As illustrated in FIG. 3, the valve assembly comprises a mounting cup 106, a mounting gasket 108, a valve body 110, a valve stem 112, a stem gasket 114, an actuator cap 116, and a return spring 118. The valve stem 112, stem gasket 114, and return spring 118 are disposed within the valve body 110 and are movable relative to the valve body 110 to selectively control dispensing of the liquid product. The valve body 110 is affixed to the underside of the mounting cup 106, such that the valve stem 112 extends through, and projects outwardly from, the mounting cup 106. The actuator cap 116 is fitted onto the outwardly projecting portion of the valve stem 112 and is provided,with an exit orifice 132. The exit orifice 132 directs the spray of the liquid product into the desired spray pattern. A dip tube 120 is attached to the lower portion of the valve body 110 to supply the liquid product to the valve assembly to be dispensed. In use, the whole valve assembly is sealed to the container about its periphery by mounting gasket 108.

In operation, when the actuator cap 116 is depressed, the valve stem 112 is unseated from the mounting cup 106, which unseals the stem orifice 126 from the stem gasket 114 and allows the propellant to flow from the container, through the valve stem 112. Flow occurs because propellant forces the liquid product up the dip tube 120 and into the valve body 110 via a body orifice 122. In the valve body 110, the liquid product is mixed with additional propellant supplied to the valve body 110 through a vapor tap 124. The vapor tap 124 introduces additional propellant gas into the valve body 110, in order to help prevent flashing of the liquefied propellant, and to increase the amount of pressure drop across the exit orifice, which has the added benefit of further breaking-up the dispensed particles. From the valve body 110, the product is propelled through a stem orifice 126, out the valve stem 112, and through an exit orifice 132 formed in the actuator cap 116.

S. C. Johnson & Son, Inc. (S. C. Johnson) employs an aerosol valve similar to that shown in FIG. 3 in connection with their line of Glade® aerosol air fresheners. The propellant used to propel the air freshener liquid product from the container is a B-Series liquefied gas propellant having a propellant pressure of 40 psig (B-40), at 70 degrees F. (2.72 atm at 294 K). “Propellant pressure” refers to the approximate vapor pressure of the propellant, as opposed to “can pressure,” which refers to the initial gauge pressure contained within a full aerosol container. The B-40 propellant is a composition of propane, normal butane, and isobutane. By normal butane it is meant the composition denoted by the chemical formula C4H10, having a linear backbone of carbon. This is in contrast to isobutane, which also has the chemical formula C4H10, but has a non-linear, branched structure of carbon. In order to effectively dispense this air freshener composition, the aerosol dispenser used by S. C. Johnson in connection with their line of Glade® aerosol air fresheners has a stem orifice diameter of 0.025″ (0.635 mm), a vapor tap diameter of 0.020″ (0.508 mm), a body orifice diameter of 0.062″ (1.575 mm), and a dip tube inner diameter of 0.060″ (1.524 mm). This current Glade® aerosol air freshener requires that the B-40 propellant be present in the amount of approximately 29.5% by weight of the contents of the dispenser assembly in order to satisfactorily dispense the air freshener liquid product.

Hydrocarbon propellants, such as B-40, contain Volatile Organic Compounds (VOCs). The content of VOCs in aerosol air fresheners is regulated by various federal and state regulatory agencies, such as the Environmental Protection Agency (EPA) and California Air Resource Board (CARB). S. C. Johnson continuously strives to provide environmentally friendly products and regularly produces products that exceed government regulatory standards. It is in this context that S. C. Johnson set out to produce an aerosol dispenser assembly having a reduced VOC content.

One way to reduce the VOC content in such aerosols is to reduce the amount of the propellant used to dispense the liquid product. However, we have discovered that a reduction in the propellant content adversely affects the product performance. Specifically, reducing the propellant content in the aerosol air freshener resulted in excessive product remaining in the container after the propellant is depeleted (product retention), an increase in the size of particles of the dispensed product (increased particle size), and a reduction in spray rate, particularly as the container nears depletion. It is desirable to minimize the particle size of a dispensed product in order to maximize the dispersion of the particles in the air and to prevent the particles from “raining” or “falling out” of the air. Thus, we set out to develop an aerosol dispenser assembly that can satisfactorily dispense an aerosol product that contains, at most, 25% by weight, of a liquefied gas propellant, while actually improving product performance throughout the life of the dispenser assembly.

Consequently, our design method tackled the idea of identifying preferred performance characteristics of a spray dispenser (in this case, product retention, increased particle size, and the spray rate, which suffer when the VOC content is reduced) and providing a novel system for calculating design variables/factors of a spray dispenser that achieve the desired performance characteristics. In other words, in developing a preferred aerosol dispenser assembly that achieved the preferred spray attributes with a reduced VOC content, we simultaneously developed a novel method of calculating design variables that can achieve any one of a number of possible performance characteristics without the need for repetitive trial and error.

Given the effect of VOC's on the environment, expected government restrictions on the VOC content through government regulations in the future, and the ever changing desires of customers of such products unrelated to VOC content, our system is not only useful in developing our own products, but also in providing consultation, for a fee, to other manufacturers and the like that desire enhancements for future spray dispenser products, aerosol or otherwise.

Our examples focus on aerosol dispensers inasmuch as we are interested in reducing VOC content while optimizing preferred spray attributes. In non-aerosol dispensers, it is still desired to optimize performance characteristics to please customers and/or provide a device that is more cost effective or easier to manufacture. On of ordinary skill in the art would understand that our methods will also apply to non-aerosol

To the extent that the following discussion focuses on aerosol dispenser, it should be noted that the “life of the dispenser assembly” is defined in terms of the amount of propellant within the container (i.e., the can pressure), such that the life of the dispenser assembly is the period between when the pressure in the container is at its maximum (100% fill weight) and when the pressure within the container is substantially depleted, i.e., equal to atmospheric pressure. It should be noted that some amount of liquid product may remain at the end of the life of the dispenser assembly. As used herein, all references to pressure are taken at 70° F. (294 K), unless otherwise noted.

One known method of reducing the particle size of a dispensed liquid product is disclosed in U.S. Pat. No. 3,583,642 to Crowell et al. (the '642 patent), which is incorporated herein by reference. The '642 patent discloses a spray head that incorporates a “breakup bar” for inducing turbulence in a product/propellant mixture prior to the mixture being discharged from the spray head. Such turbulence contributes to reducing the size of the mixture particles discharged from the spray head.

### SUMMARY OF THE INVENTION

Our invention provides a method of determining design parameters for a design of an improved spray dispenser and designing the same. More preferably, our invention is directed to designing an improved aerosol dispenser assembly that dispenses substantially all of a liquid product (i.e., reduces product retention), in accordance with a predetermined set of performance characteristics. For example, in an air freshener, consumers prefer a specific particle size range and discharge rate. On the other hand, for furniture polishes, cone angle is a more critical performance characteristic. More generally, our invention is directed to a method of designing a spray dispenser by calculating which design factors, or combination thereof, will enhance and/or enable preferred characteristics of the spray dispenser.

In one aspect, our method is directed to a method of providing for a client a service of determining design parameters for a design of a spray dispenser assembly for dispensing a mist and designing the same. The method includes identifying one or more preferred performance characteristics of the spray dispenser to be designed and identifying design variables of structures of a spray dispenser assembly that affect the one or more performance characteristics. In addition, the method includes obtaining test data indicative of performance characteristics of spray dispensers at different combinations of values of the identified design variables and defining design parameters for the identified design variables, based on the test data. Consequently, the defined design parameters provide the one or more preferred performance characteristics when embodied in a spray dispenser. The defined parameters can be one or more ranges of design variable values that will provide a spray dispenser with the desired characteristics, or specific values.

In another aspect, our invention is directed to a method of determining design parameters for a design of an improved spray dispenser and designing the same. The method includes determining the client's one or more preferred performance characteristics for the spray dispenser assembly to be designed. Once the preferred characteristic(s) are determined, the method includes identifying design variables of structures of a spray dispenser assembly that affect the one or more performance characteristics. In addition, the method includes obtaining test data indicative of performance characteristics of spray dispensers at different combinations of values of the design variables. Based on that obtained test data, a step is performed of defining design parameters for the identified design variables which provide the one or more preferred performance characteristics when embodied in a spray dispenser.

In yet another aspect, our invention is directed to another method of designing a spray dispenser assembly for dispensing a mist. This method also includes identifying one or more preferred performance characteristics of the spray dispenser to be designed. In addition, the method includes testing design variables of structures of a spray dispenser assembly that affect the one or more performance characteristics to determine the extent to which variations in a given design variable affect the one or more performance characteristics. Further, primary design variables are selected based on the above determination and testing is performed on the effects different combinations of the primary design variables have on the one or more performance characteristics, in order to determine interdependencies and relationships of those primary design variables in affecting the one or more performance characteristics. Based on the test data, there are determined design parameters for the primary design variables which provide the one or more preferred performance characteristics when embodied in a spray dispenser.

In addition to these methods, our invention also includes the production of a database that can store much of the data necessary for performing the recited methods. More specifically, the performance of the above-discussed methods may involve the performance of experiments to obtain test data on which the determinations are made and, when those experiments are a sampling of the total experimental data needed, the calculation of the remaining test data through statistical modeling. This data may be saved to create a database of test data. As the database grows, it may be used to avoid repeating the same experiments and statistical analysis in the future. Accordingly, the steps of performing experimentation to obtain test data and statistical analysis of the test data may simply involve obtaining the information from a database, inasmuch as inclusion of the information in the database indicates the necessary testing and calculations have already been performed.

In air fresheners, average particle size, as used herein, means average mean particle size D(V,0.5) of the dispensed product, as measured by laser diffraction analysis by a Malvern® Mastersizer 2600 Particle Size Analyzer, the aerosol assemblies being sprayed from a horizontal distance of 11-16.0″ (27.5-40.6 cm) from the measurement area, and having a maximum cutoff size of 300 microns. This term is equivalent to mass mean particle size.

As used herein to describe any quantity, dimension, range, value, or the like, the term “about” is intended to encompass the range of error that occurs during any measurement, variations resulting from the manufacturing process, variation due to deformation during or after assembly, or variation that is the compounded result of one or more of the foregoing factors.

A better understanding of these and other aspects, features, and advantages of the invention may be had by reference to the drawings and to the accompanying description, in which preferred embodiments of the invention are illustrated and described.

### BRIEF DESCRIPTION OF THE DRAWINGS

FIG. 1 is a cross-sectional perspective view of a first embodiment of the valve of the present invention.

FIG. 2 is a front view of the aerosol dispenser assembly of the first embodiment, with the container cut away for clarity.

FIG. 3 is an exploded view of a conventional aerosol valve assembly and actuator cap, illustrating the individual components.

FIG. 4 is a bar graph showing the relative effects,of different variables of a spray dispenser design on spray dispenser performance characteristics.

FIGS. 5A-5F show summaries of effects of different dispenser variables on various spray dispenser performance characteristics.

FIG. 6 is an example of a contour graph showing product retention as a function of vapor trap and propellant level.

FIG. 7 is an example of a contour graph showing product retention as a function of body orifice size and vapor tap size.

Throughout the figures, like or corresponding reference numerals denote like or corresponding parts.

### DESCRIPTION OF THE PREFERRED EMBODIMENTS

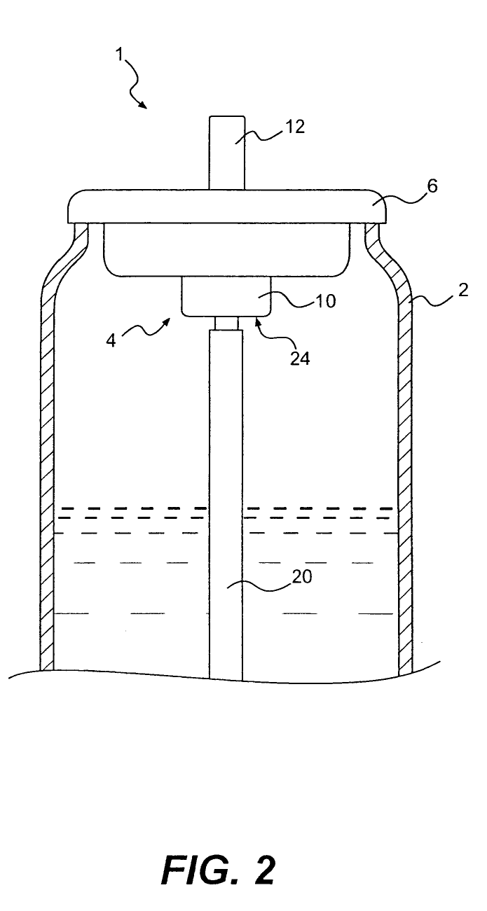

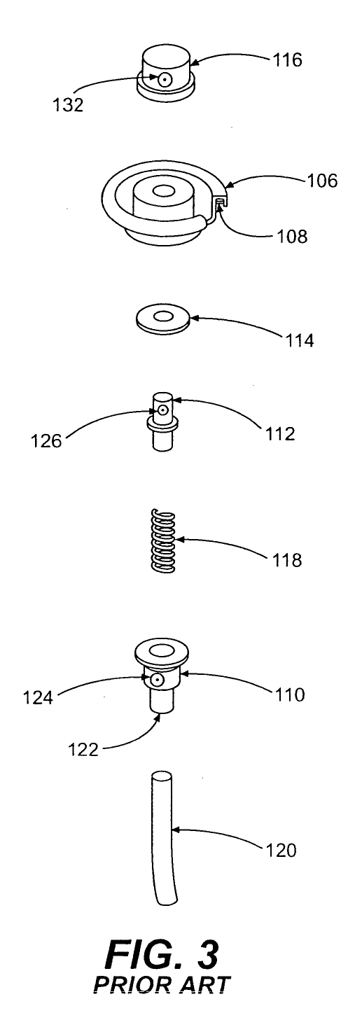

As shown in FIG. 2, an aerosol dispenser assembly according to our invention generally comprises a container 2 with a valve assembly 4 disposed in the top thereof for selectively dispensing a liquid product from the container 2.

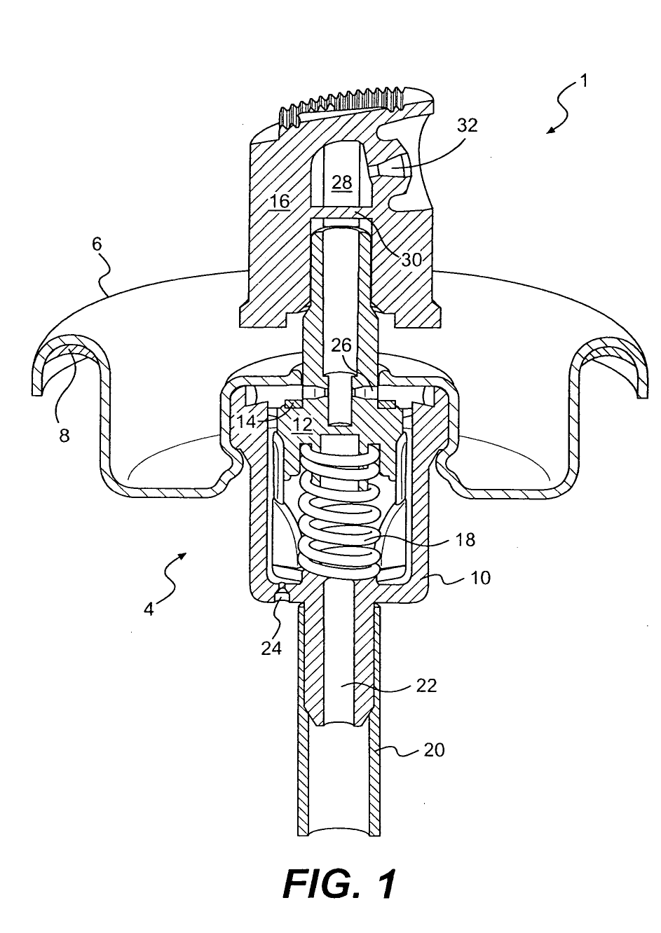

With reference to FIG. 1, the valve assembly 4 further comprises a mounting cup 6, a mounting gasket 8, a valve body 10, a valve stem 12, a stem gasket 14, an actuator cap 16, and a return spring 18. The actuator cap 16 defines an exit path 28 and an actuator orifice 32. The valve stem 12, stem gasket 14, and return spring 18 are disposed within the valve body 10 and are movable relative to the valve body 10. The valve body 10 is affixed to the underside of the mounting cup 6, such that the valve stem 12 extends through, and projects outwardly from, the mounting cup 6. The actuator cap 16 is fitted onto the outwardly projecting portion of the valve stem 12, and a dip tube 20 is attached to the lower portion of the valve body 10. The whole valve assembly 4 is sealed to the container 2 by mounting gasket 8.

While the dispenser assembly shown in FIG. 1 employs a vertical action-type cap 16, it will be understood that any suitable valve type may be used, such as, for example, a tilt action-type cap. In addition, instead of the simple push-button actuator cap 16 shown in FIG. 1, it will be understood that any suitable actuator may be used, such as, for example, an actuator button with an integral overcap, a trigger actuated assembly, or the like.

In operation, when the actuator cap 16 of the dispenser 1 is depressed, it forces the valve stem 12 to move downward, thereby allowing the liquid product to be dispensed. The propellant forces the liquid product up the dip tube 20 and into the valve body 10 via body orifice 22. In the valve body 10, the liquid product is mixed with additional propellant supplied to the valve body 10 through a vapor tap. 24. The additional propellant introduced through the vapor tap 24 prevents flashing of the liquefied propellant, and increases the amount of pressure drop across the exit orifice, which simultaneously increase the particle break-up. From the valve body 10, the liquid product is propelled through at least one stem orifice 26, out the valve stem 12, and through an exit path 28 formed in the actuator cap 16. A single stem orifice may be used; however, we have found that using two (as shown in FIG. 1), or preferably four, stem orifices 26 spaced around the periphery of the valve body 10 facilitates greater flow and superior mixing of the product as it is dispensed.

FIG. 1 depicts a breakup bar 30 in the exit path 28, such that the product is forced to diverge around the breakup bar 30, thereby inducing turbulence in the flow of the product, further reducing the particle size of the product. The product is then expelled from the actuator cap 16 through an actuator orifice 32, which disperses the product and produces a desired spray pattern. Instead of a breakup bar as shown in FIG. 1, the dispenser assembly might employ a pair of breakup plates positioned in or below the exit path 28, a swirl chamber positioned immediately upstream of the exit orifice 32, or other similar mechanical breakup features. While mechanical breakup features provide some additional break-up of the product prior to being dispensed, we have found that other factors have a much greater impact on particle size than these mechanical breakup features. Nonetheless, these mechanical breakup features may be used to even further reduce the size of the dispensed particles, but such mechanical breakup features are not necessary or preferred.

As noted above, we found that reducing the hydrocarbon propellant content of an aerosol air freshener to at most 25% by weight adversely affected the product performance. Specifically, reducing the propellant content in the aerosol air freshener resulted in excessive product retention, decreased spray rate as the container became depleted, and an increased particle size. Consequently, the air freshener exhibited excessive raining or falling out of the liquid product. In order to correct these adverse effects, we tested various different types of propellants, pressures, and valve orifice dimensions to set a threshold design on which to develop our system of designing an improved spray dispenser.

In particular, we tested two types of propellants, A-Series and B-Series propellants. Both types of propellants were found to be suitable for dispensing a liquid product from a container. We found, however, that the A-Series propellants that we tested unexpectedly produced a mist having a significantly smaller particle size than did the B-series propellants, under the same conditions. This difference was especially pronounced toward the end of the life of the dispenser assembly, when the pressure remaining in the container was lower. We believe that the superior mist producing ability of the A-Series propellants is due to the absence of normal butane in the A-Series propellants. As described above, the B-Series propellants contain a combination of propane, normal butane, and isobutane. In contrast, the A-series propellant does not contain any normal butane. When the dispenser assembly is shaken prior to use, the liquid product and the propellant form an oil-out emulsion. That is, small droplets of the liquid product are coated with a layer of fragrance oil and propellant, the aqueous phase liquid product being suspended in a layer of non-aqueous phase propellant and fragrance oil. When the emulsion is expelled from the pressurized dispenser assembly, the liquefied gas instantly evaporates, causing the droplets to “burst” and creating a fine mist of liquid product in the air. The absence of normal butane in the A-Series propellant is thought to facilitate a greater burst of mist, thereby reducing the particle size of the dispensed mist. This reduced particle size allows a greater amount of the dispensed product to remain suspended in the air for a longer period of time, thus, increasing the air freshening efficacy of the product.

While the invention is disclosed as being primarily used in connection with a hydrocarbon propellant, it should be understood that the invention could be adapted for use with other sorts of propellants. For example, HFC, dimethyl ether (DME), and CFC propellants might also be used in connection with a variation of the dispenser assembly of our invention. Also, it should be noted that propellants are typically only necessary in aerosol devices. While a preferred embodiment involves designing aerosol dispensers, other embodiments may include other spray dispensers, such as pump spray devices in which a pumping mechanism is used in the place of a propellant. Other such spray dispensers are readily known in the art.

We tested various different propellant pressures and found that, in general, higher-pressure propellants tended to dispense the product as a mist having smaller particle size than did lower-pressure propellants. In addition, the higher-pressure propellants somewhat reduced the amount of product retained in the container at the end of the life of the dispenser assembly. However, simply increasing the pressure in the prior art aerosol dispensers, without more, was found to be insufficient to expel a satisfactory amount of the liquid product from the container. Thus, we also examined the aerosol valve itself to determine how best to reduce the amount of product retention, while maintaining a satisfactorily small particle size of the dispensed product.

In order to minimize the amount of product retention of the dispenser assembly, we found that it was desirable to increase the amount of liquid product dispensed per unit of propellant. That is, by making the dispensed ratio of liquid product to propellant smaller (i.e., creating a leaner mixture), the same amount of propellant will be able to exhaust a greater amount of liquid product. Several valve components are known to affect the dispensed ratio of liquid product to propellant, including the vapor tap, the stem orifice, the body orifice, the exit orifice, and the inner diameter of the dip tube.

In general, we found that decreasing the size of the vapor tap has the effect of creating a leaner mixture. However, reducing the size of the vapor tap also has the side effect of increasing the particle size of the dispensed product. Conversely, we found that decreasing the size of the stem orifice, body orifice, exit orifice and/or dip tube inner diameter generally decreases the spray rate and the particle size.

Based on the above observations, we discovered that certain combinations of propellant type, can pressure, and valve orifice dimensions, produced a dispenser assembly that contains at most 25% by weight of a hydrocarbon propellant and has superior product performance over the prior art dispenser assemblies.

We also found that A-Series propellants, which are free from normal butane, exhibit reduced particle size of the dispensed product.

A dispenser assembly having a can pressure of between 55 psig (3.74 atm) and 120 psig (8.17 atm) was found to help reduce product retention while also reducing the particle size of the dispensed product. As noted above, can pressure refers to the initial gauge pressure contained within the aerosol container. Still higher pressures could also be effectively used to dispense the liquid product from the container. As the pressure within the aerosol dispenser assembly is increased, however, the strength of the aerosol dispenser container (also referred to as an aerosol can) must also be increased. Federal regulations (DOT ratings) govern the strength of pressurized containers and specify that aerosol cans must meet a certain can rating for a given internal pressure. Specifically, aerosol cans having an internal pressure of 140 psig or less at 130° F. (9.53 atm at 327 K) are known as “regular” or “unrated,” since a higher DOT rating is not required. Aerosol cans having an internal pressure of 160 psig or less at 130° F. (10.9 atm at 344 K) have a DOT rating of 2 P, and cans having an internal pressure of 180 psig or less at 130° F. (12.3 atm at 355 K) have a DOT rating of 2 Q. The higher the specified can rating, the stronger the aerosol can must be. Generally, a can having a higher rating will be more costly due to increased material and/or manufacturing costs. Thus, in order to minimize costs, it is preferable to use the lowest pressure possible while still maintaining satisfactory product performance. In this regard, we found that can pressures of between 55 psig (3.74 atm) and 80 psig (5.44 atm), again measured at 70 degrees F. (294 K), were especially preferred because they require a lower can rating than would higher can pressures and are still capable of achieving the advantages of the present invention (i.e., reduced propellant content, reduced particle size, and minimal product retention).

We also found that the dispenser assembly of FIG. 1 was capable of satisfactorily dispensing an aerosol product that contains at most 25% by weight of a liquefied gas propellant, when the diameter of the vapor tap 24 is between about 0.013″ (0.330 mm) and about 0.019″ (0.483 mm), the diameter of the stem orifice 26 is between about 0.020″ (0.508 mm) and about 0.030″ (0.762 mm) when a single stem orifice is used (between about 0.014″ (0.356 mm) and about 0.025″ (0.635 mm) when a pair of stem orifices are used), the diameter of the body orifice is between about 0.050″ (1.270 mm) and about 0.062″ (1.575 mm), the diameter of the exit orifice 32 is between about 0.015″ (0.381 mm) and about 0.022″ (0.559 mm), and the inner diameter of the dip tube is between about 0.040″ (1.016 mm) and about 0.060″ (1.524 mm).

Thus, any of the above-described valve components, propellant types, propellant pressures, and valve orifice dimensions, may be used in combination to provide a dispenser assembly according to our invention.

In a first preferred embodiment of the invention, the aerosol dispenser assembly 1 uses an A-Series propellant having a propellant pressure of about 60 psig (4.1 atm) (i.e., A-60 propellant) to dispense the liquid product from the container 2. In this embodiment, the container is initially pressurized to a can pressure of about 70 psig (4.8 atm) to about 80 psig (5.4 atm). The diameter of the vapor tap 24 in this embodiment is about 0.016″ (0.406 mm). Two stem orifices 26 are used, each having a diameter of about 0.024″ (0.610 mm). The diameter of the body orifice is about 0.050″ (1.270 mm), the diameter of the exit orifice 32 is about 0.020″ (0.508 mm), and the inner diameter of the dip tube is about 0.060″ (1.52 mm). Furthermore, a breakup bar 30 is positioned in the exit path 28 of the actuator 16 in order to further reduce the particle size of the dispensed product.

A second preferred embodiment of the dispenser assembly 1 employs a single stem orifice 26. In this embodiment, the dispenser assembly 1 also uses the A-60 propellant and a can pressure of about 70 psig (4.8 atm) to about 80 psig (5.4 atm) to dispense the liquid product from the container 2. The diameter of the vapor tap is about 0.016″ (0.406 mm), the diameter of the single stem orifice is about 0.025″ (0.635 mm), the diameter of the body orifice is about 0.062″ (1.575 mm), and the inner diameter of the dip tube is about 0.060″ (1.524 mm). This embodiment also employs a breakup bar, positioned in the exit path of the actuator to further reduce the particle size of the dispensed product. The following table T.1 describes the performance of the dispenser assemblies according to the first and second preferred embodiments, respectively.

TABLE 1
Performance of Embodiments One and Two

| Propellant Type | A-60 | A-60 |
|---|---|---|
| Propellant Level (wt. %) | 24.5 | 24.5 |
| Body Orifice Diameter (mm) | 1.58 | 1.27 |
| Vapor Tap Diameter (mm) | 0.406 | 0.406 |
| Stem Orifice Area (mm²) | 0.317 | 0.584 |
| Exit Orifice Diameter (mm) | 0.508 | 0.508 |
| Dip Tube Diameter (mm) | 1.52 | 1.52 |
| Mechanical Breakup | Yes | Yes |
| Spray Rate (g/s) 100% Full | 1.23 | 1.27 |
| 75% Full | 1.18 | 1.15 |
| 50% Full | 1.15 | 1.12 |
| 25% Full | 1.07 | 1.05 |
| Particle Size (μm) 100% Full | 29 | 29 |
| 75% Full | 30 | 30 |
| 50% Full | 29 | 32 |
| 25% Full | 32 | 34 |
| Retention (wt. %) | 1.26 | 1.76 |

These preferred embodiments of the dispenser assembly are capable of dispensing the liquid product contained within the container as a mist having an average particle size of less than 35 micrometers (0.0014″), over at least 75% of the life of the dispenser assembly. Because the dispensed mist has such a small particle size, the particles are more easily dispersed in the air and less fallout is experienced. This reduction in the amount of fallout increases the dispenser assembly's air freshening efficacy and helps to prevent undesirable residue of the liquid product from settling on flat surfaces, such as, countertops, tables, or floors.

Moreover, both preferred embodiments of the dispenser assembly are capable of: dispensing over 98% by weight of the liquid product from the container. It is important that substantially all of the product can be dispensed, to ensure that product label claims will be met. Also, by minimizing the amount of product retained in the container at the end of the life of the dispenser assembly, less liquid product is wasted. This is important from a consumer satisfaction standpoint, since consumers tend to be more satisfied with a dispenser assembly when substantially all of the liquid product can be dispensed.

With the foregoing preferred embodiments as a threshold, we began to take a more focused approach to reducing the propellant content of a dispenser assembly even further. Our goal at this stage was to produce an aerosol dispenser assembly that could effectively dispense its contents using as little propellant as possible, but not more than about 15% liquefied gas propellant by weight. In doing so, we also developed a method of achieving improved dispenser characteristics through a novel system of analyzing factors affecting such attributes and calculating preferred combinations of the same to achieve the desired attributes. At the outset, we note that as the propellant content was reduced below about 15%, the stability of the product propellant emulsion began to break down. That is, at lower propellant levels, the oil-out emulsion inverted to a water-out emulsion, thereby deteriorating the performance characteristics. In contrast to an oil-out emulsion, a water-out emulsion contains small droplets of a non-aqueous phase suspended in an aqueous phase. We found that this inversion can be prevented by adjusting the emulsifier. For example, lowering the liquefied gas propellant level from 25% to 10% inverted the emulsion. Addition of 0.03% by weight of trimethyl stearyl ammonium chloride prevented the inversion. Of course, various other stabilizers in various different amounts may also be effectively used to prevent the inversion of the emulsion.

We first identified several “performance characteristics” upon which to measure the performance of a given dispenser assembly configuration. For this embodiment, the performance characteristics identified were (1) the average diameter D in micrometers of particles dispensed during the first forty seconds of spray of the assembly, (2) the average spray rate Q in grams/second during the first forty seconds of spray of the assembly, and (3) the amount of the product R remaining in the container at the end of the life of the assembly, expressed as a percentage of the initial fill weight. As used herein, the term “fill weight” refers to the weight of all of the contents of the container, including both the liquid product and the propellant.

Based on consumer testing and air freshening efficacy, the particle size, D, should preferably be in the range of about 15 and about 60 micrometers, more preferably between about 25 and about 40 micrometers, and most preferably between about 30 and about 35 micrometers. The spray rate is preferably between about 0.6 and about 1.8 g/s, more preferably between about 0.7 and about 1.4 g/s, and most preferably between about 1.0 and about 1.3 g/s. The amount of liquid product remaining in the can at the end of life of the dispenser assembly is preferably less than about 3% of the initial fill weight, more preferably less than about 2% of the initial fill weight, and most preferably less than about 1% of the initial fill weight. Of course, which performance characteristics to study will depend on the particular product to be designed. For instance, the present embodiment is directed to improving an aerosol-based air freshener. In other embodiments, furniture sprays, deodorants and the like could be studied, in which case the characteristics necessary to please a customer may also vary. Other important spray attributes that could be identified and studied include, but are not limited to, obscuration (a measure of “optical thickness” relating to concentration of the particles), plume distance, fill speed, sputter point, stream point, can pressure, relative span factor, particle concentration, cone angle, fallout, sound levels, and spray down (a measure of the time the device takes to regain pressure after repeated uses intended to deplete the pressure level).

Also, when a non-aerosol device is used, the characteristics of importance may also change. For example, in a spray dispenser that uses pump action to dispense the mist (e.g., a trigger-type spray bottle), retention, sputter point, stream point, and can pressure are not relevant. Also, some trigger sprays introduce air into the liquid to cause a foam to be sprayed, in which case the air entrapment could be a characteristic of interest.

The desired performance characteristics can be identified by, at least, internal analysis by designers in the field, consumer testing, and/or, when the method is being performed as a service, provided by a customer/client.

Such identifications, however, may only provide consumer-described spray attributes that are merely subjective observations. It is necessary to convert such subjective descriptions into instrumentally measurable values. This is achieved by establishing correlation coefficients between consumer benefit statements and instrumental measurements. For example, a consumer could describe that the spray is cloudy or that the spray has a tendency to “rain” (i.e., droplets rain down from the plume). To establish the identity of the quantifiable performance characteristics and preferred values for the same, we would provide a focus group with a plurality of spray dispensers that vary in only one characteristic (e.g., particle size), and then gauge the group's preferences. Thus, objectively quantifiable values can be established based on the ratings of the different sprays. This can be repeated as necessary for different characteristics.

Once the performance characteristics to be analyzed are identified, it is necessary to determine factors that are known, or thought, to affect one or more of these performance characteristics. Ultimately, in this embodiment, these factors included propellant content, dip tube inner diameter, body orifice diameter, vapor tap diameter, stem orifice diameter, mechanical breakup elements, exit orifice diameter, and land length (essentially the axial length of the exit orifice). Examples of factors in trigger spray devices could include the exit orifice size, land length of the exit orifice (i.e., the length of the exit orifice through which the ejected mist travels), barrel volume (i.e., the volume in the barrel through which a plunger moves to provide the pressure to eject the mist), chamber volume (i.e., the volume of the chamber into which the contents of the barrel are ejected), dip tube inner diameter, and inner diameter of the barrel.

Once these factors are identified, they need to be optimized. In some instances, as a practical matter, there are too many factors to analyze the interactions of the factors. In these cases, a sifting tool such as a 2^{k} factorial analysis may be employed to identify the factors of primary interest. Then we employ a statistical tool to measure interactions of those primary factors in order to optimize the same. A description of various tools for performing such optimization analyses can be found in statistic text books such as “Design and Analysis of Experiments” by Doulas C. Montgomery, published by John Wiley and Sons, New York, 1997.

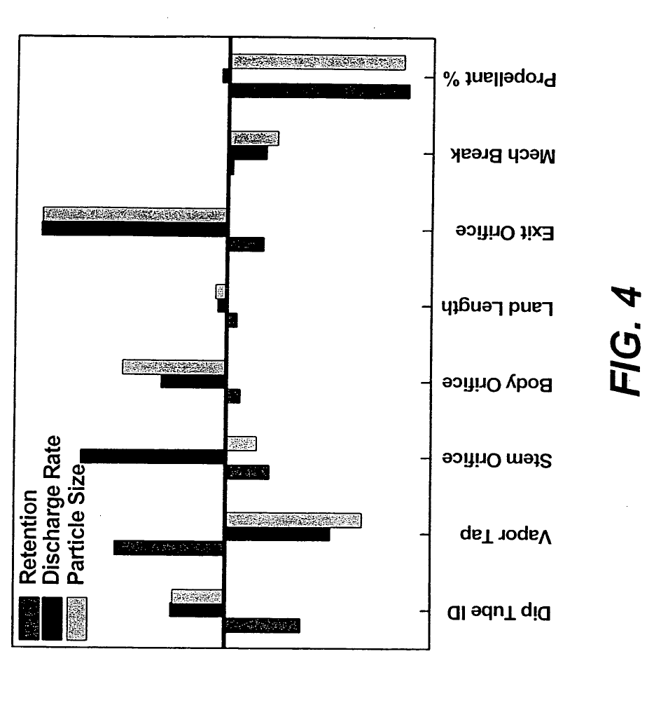

To determine these factors, initial experiments were conducted, varying each of these factors individually, as well as others, to determine the magnitude of the effect each factor had on the performance characteristics. The control platforms used for the initial testing were the original Glade dispenser assembly and the above-described first and second preferred embodiments. One or more of these platforms was then modified to vary each of the above factors individually. The magnitude of the effect each above-listed factor had on the performance characteristics was determined using a 2^{k} factorial experimental design. The results of these calculations are shown graphically in FIG. 4.

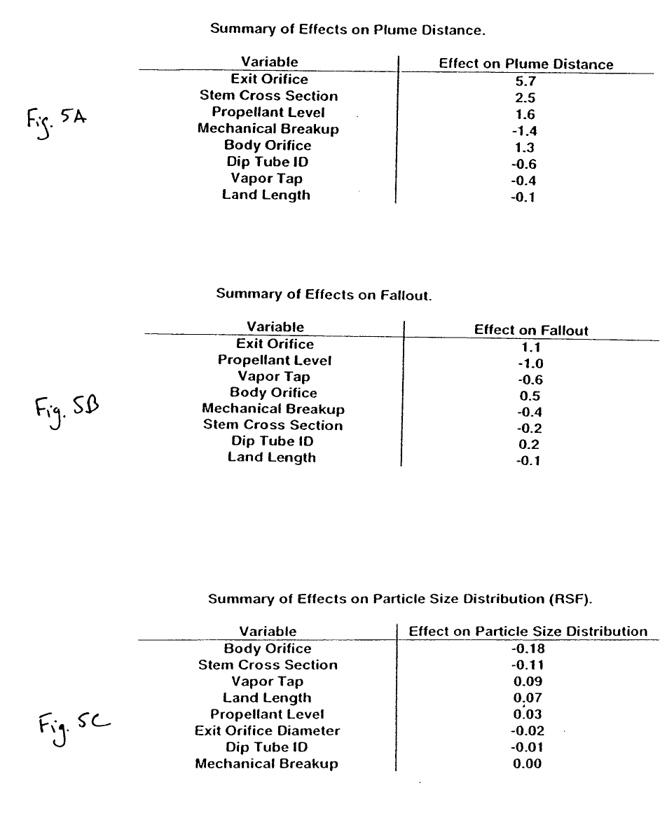

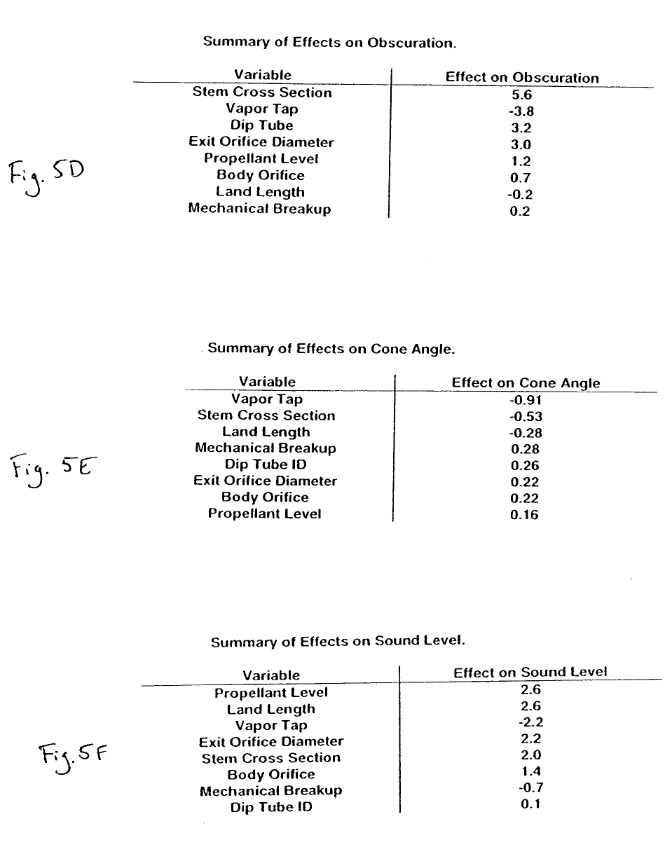

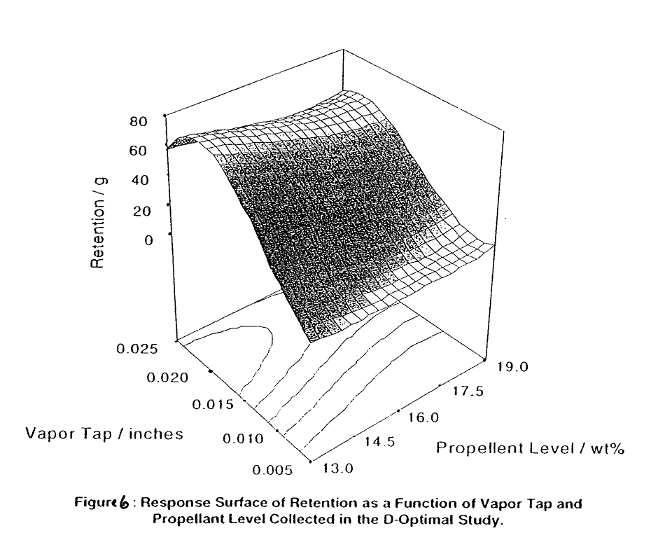

The 2^{k} factorial design was also performed with respect to other performance characteristics, as shown in FIGS. 5A-5F. As would be appreciated by one ordinary skill in the art, numerous other performance characteristics could be studied using the listed factors, as well as other such factors. Because retention, discharge rate and particle size were of primary importance in this embodiment, we focused on the same for this embodiment.

From this list we selected the five factors (“critical factors”) having the greatest effect (negative or positive) on the important performance characteristics to perform further experimentation. The critical factors selected were dip tube inner diameter, vapor tap diameter, body orifice diameter, stem orifice diameter, and exit orifice diameter.

Thus, the 2^{k} factorial design was primarily used to identify primary factors to be studied. More specifically, lacking in the 2^{k} factorial design is an assessment of variable interactions. It is possible that the effects of important factors are interdependent; that is, their responses are not linear with respect to one another. To address the interaction, a matrix study is preferred. Traditionally, matrix experiments measure variable interactions. Valve requirements do not lend themselves to matrix experiments. The number of variables to measure is simply too large. If run at three different levels, ten variables would require 1000 experiments. And this would only yield quadratic interaction terms. As will be discussed below, cubic terms come into the picture. Cubic terms require no fewer than 5 levels of each variable, or 100,000 experiments.

Fortunately, modern statistics provides a tool for reducing the number of experiments to a manageable number. A software package from Stat-Ease, Inc. (Design Expert) is a particularly useful statistical tool for this problem.

Thus, instead of using the Box-Behnken design or the D-Optimal design from the outset, it was therefore desirable to begin with the factorial screening design discussed above. Once the 2^{k} factorial design was completed, the variables with the largest primary effects were selected for optimization. Thus, screening designs can be used to reduce experiment requirements down to a manageable number. Conclusions from such a screening design should be taken as interesting and suggestive, but not definitive. The purpose of the screening design is to identify the most important factors. More detailed study is required to optimize those factors.

In this embodiment, the important variables identified were propellant level, exit orifice, vapor tap, body orifice, and dip tube inner diameter. Particle size was increased by reducing the propellant level (the project goal) and reducing the vapor tap size (conserves propellant), and was decreased by making the exit orifice smaller. This suggests that performance changes in particle size, due to reduced propellant levels and smaller vapor taps, can be offset by decreasing the size of the exit orifice. In order to reduce the exit orifice size, the stem cross section should be enlarged to maintain discharge rate.

While we knew that the critical factors had a pronounced effect on the performance characteristics, we were unsure if they varied independently of one another. To determine interdependencies, it was necessary to generate a table showing performance characteristics for every combination of every value of the critical factors within a desired range.

If each of the critical factors was to be varied through ten different sizes, for instance, it would have required one hundred thousand different trials to complete the table referred to above. Rather than run all of those different experiments, we used a Response Surface Method to select a limited sample of experiments. Based on our limited sample of experiments, we were able to generate a complete table of performance characteristics for every possible variation of the critical factors, using the Response Surface Method to interpolate the missing data points. Fifty-seven experiments were conducted—a Box-Behnken Design consisting of twenty-nine experiments, the results of which are set forth in table T.2 below, and a D-Optimal Design consisting of twenty eight experiments, the results of which are set forth in table T.3 below. Descriptions of these two methods can be found in “Design and Analysis of Experiments.”

A single design capable of predicting cubic interaction terms was not possible in this situation because, as discussed, the required combinations of variables were not readily available from valve suppliers. Also, as discussed above, where there are fewer factors to analyze, the critical factors can be determined without a 2^{k} factorial design. Other combinations of design screenings may also be employed depending on the circumstances and limitations of the individual analyses.

The data was entered to the design expert software and modeled with cubic terms. The D-optical design uses seven levels of each variable and is specifically designed to obtain excellent modeling with cubic terms. The quality of modeling is, of course, limited by the quality of the data used to generate the model.

FIG. 6 shows the retention level on the z-axis, as a function vapor tap on the x-axis and propellant level on the y-axis, in the form of a contour graph. FIG. 6 is just one example of such modeling that can be achieved using the D-optimal design data. The important idea to be exemplified by this graph is that the vapor tap has a far greater effect on the retention than, the propellant level. The propellant level has only a slight effect on the retention, rising gradually as propellant level drops.

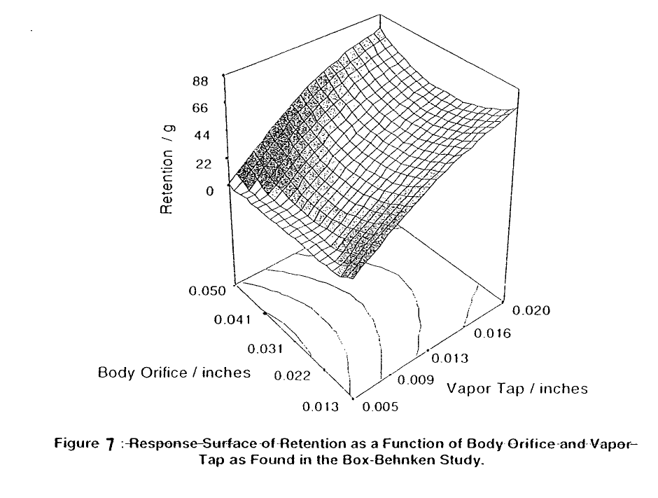

Body orifice and dip tube ID were not available in the multitude of levels required for a D-optimal study, so a second, Box-Behnken-type experiment set was developed around these data using only three levels of each variable. The Box-Behnken experiment varied four variables from high to low. The 3-D graphic procedure allowed us to apply any two variables against each other while holding the other two variables fixed. With four variables, there are six unique combinations of variables that can be applied against each other. Assuming that the other variables are held constant at high, medium, or low settings, then there are five plots for each variable combination. In total, to completely show the response surface of a single response, thirty plots would be required. With three essential responses (particle size, spray rate and retention) a total of ninety graphs would be required to show this complete picture. A discussion of all such graphs is not necessary for purposes of describing the present embodiment. However, for explanatory purposes, FIG. 7 shows one such graph. The plot of retention as a function of body orifice and vapor tap shows that the vapor tap exhibits quick control over the retention, while the body orifice has a slight effect.

Accordingly, because of all of the factors analyzed in our study, a large amount of data was obtained. In order to simplify the “optimization” process, we tried to combine the responses into a single factor. This single factor is a combination of the three factors, weighted empirically until a single number was generated that seemed to correlate well with the overall performance, as discussed in more detail below. Of course, the step proved helpful in the described embodiment, but may not be necessary in all cases. Instead, the results of the design screenings could be evaluated alone to determine the design parameters of primary factors for achieving desired performance characteristics when those factors are embodied in a spray dispenser assembly.

TABLE 2
Experimental Data for Box-Behnken Design

| | | | | | | Particle Size | Spray | Spray Rate | | |
|---|---|---|---|---|---|---|---|---|---|---|
| | Exit | Vapor | Dip | Body | Particle | @ 200 g Fill | Rate | @ 200 g | | |
| | Orifice | Tap | Tube ID | Orifice | Size Full | Weight | Full | Fill Weight | Retention | |
| Trial | (mm) | (mm) | (mm) | (mm) | (μm) | (μm) | (g/s) | (g/s) | (Wt. %) | CV |
| 1 | 0.635 | 0.330 | 3.099 | 0.635 | 40.0 | 47.9 | 1.408 | 1.360 | 1.62 | 27 |
| 2 | 0.330 | 0.127 | 1.524 | 0.635 | 40.0 | 38.4 | 0.716 | 0.588 | 2.70 | 31 |
| 3 | 0.635 | 0.127 | 1.524 | 0.635 | 44.7 | 47.7 | 1.451 | 1.349 | 0.00 | 35 |
| 4 | 0.457 | 0.330 | 1.524 | 0.635 | 34.7 | 36.7 | 0.877 | 0.676 | 10.23 | 36 |
| 5 | 0.457 | 0.508 | 1.016 | 0.635 | 21.7 | 89.4 | 0.555 | 0.947 | 22.59 | 38 |
| 6 | 0.457 | 0.330 | 1.524 | 0.635 | 34.6 | 37.4 | 0.847 | 0.599 | 17.34 | 54 |
| 7 | 0.457 | 0.330 | 1.524 | 0.635 | 33.8 | 38.6 | 0.860 | 0.599 | 19.34 | 57 |
| 8 | 0.457 | 0.330 | 1.016 | 0.330 | 26.9 | 62.9 | 0.618 | 0.487 | 23.59 | 53 |
| 9 | 0.457 | 0.127 | 1.524 | 0.330 | 33.8 | 41.2 | 0.716 | 0.639 | 1.78 | 13 |
| 10 | 0.457 | 0.508 | 3.099 | 0.635 | 29.1 | 40.7 | 0.666 | 0.390 | 33.55 | 84 |
| 11 | 0.330 | 0.330 | 3.099 | 0.635 | 35.2 | 33.6 | 0.567 | 0.422 | 17.22 | 58 |
| 12 | 0.457 | 0.127 | 3.099 | 0.635 | 47.8 | 48.1 | 1.282 | 1.187 | 0.00 | 41 |
| 13 | 0.330 | 0.330 | 1.016 | 0.635 | 27.5 | 55.1 | 0.431 | 0.418 | 33.40 | 82 |
| 14 | 0.457 | 0.330 | 1.524 | 0.635 | 34.9 | 38.2 | 0.826 | 0.641 | 6.60 | 27 |
| 15 | 0.457 | 0.127 | 1.016 | 0.635 | 41.3 | 41.3 | 1.018 | 0.868 | 0.15 | 24 |
| 16 | 0.330 | 0.330 | 1.524 | 1.270 | 34.7 | 27.3 | 0.565 | 0.317 | 30.08 | 90 |
| 17 | 0.330 | 0.330 | 1.524 | 0.330 | 23.1 | 46.2 | 0.353 | 0.413 | 33.59 | 72 |
| 18 | 0.330 | 0.508 | 1.524 | 0.635 | 22.7 | 44.3 | 0.357 | 0.492 | 35.37 | 76 |
| 19 | 0.457 | 0.127 | 1.524 | 1.270 | 50.0 | 48.2 | 1.357 | 1.200 | 0.00 | 48 |
| 20 | 0.457 | 0.330 | 3.099 | 0.330 | 26.8 | 64.9 | 0.618 | 0.538 | 23.71 | 54 |
| 21 | 0.457 | 0.330 | 1.524 | 0.635 | 35.1 | 38.5 | 0.904 | 0.751 | 13.05 | 44 |
| 22 | 0.635 | 0.508 | 1.524 | 0.635 | 30.8 | 51.5 | 0.975 | 0.748 | 31.04 | 79 |
| 23 | 0.457 | 0.330 | 3.099 | 1.270 | 46.1 | 43.8 | 1.186 | 0.982 | 0.00 | 36 |
| 24 | 0.635 | 0.330 | 1.524 | 1.270 | 42.0 | 49.1 | 1.354 | 1.043 | 0.83 | 30 |
| 25 | 0.457 | 0.508 | 1.524 | 0.330 | 27.3 | 61.0 | 0.620 | 0.479 | 26.33 | 61 |
| 26 | 0.457 | 0.330 | 1.016 | 1.270 | 29.1 | 50.5 | 0.723 | 0.390 | 32.74 | 82 |
| 27 | 0.635 | 0.330 | 1.524 | 0.330 | 34.4 | 45.5 | 0.731 | 0.398 | 39.11 | 111 |
| 28 | 0.635 | 0.330 | 1.016 | 0.635 | 36.6 | 52.2 | 1.043 | 0.719 | 19.65 | 63 |
| 29 | 0.457 | 0.508 | 1.524 | 1.270 | 27.2 | 56.8 | 0.671 | 0.790 | 28.73 | 67 |

TABLE 3
Experimental Data for D-Optimal Design

| | Propellant | Vapor | Exit | Particle | Spray | |
|---|---|---|---|---|---|---|
| | Content | Tap | Orifice | Size Full | Rate Full | Retention |
| Trial | (Wt. %) | (mm) | (mm) | (μm) | (g/s) | (Wt. %) |
| 1 | 14.5 | 0.508 | 0.330 | 20.0 | 0.323 | 22.15 |
| 2 | 13 | 0.635 | 0.508 | 22.3 | 0.489 | 21.15 |
| 3 | 19 | 0.635 | 0.635 | 27.4 | 0.972 | 18.63 |
| 4 | 13 | 0.406 | 0.330 | 26.7 | 0.404 | 30.46 |
| 5 | 19 | 0.127 | 0.330 | 39.8 | 0.760 | 0.00 |
| 6 | 17 | 0.635 | 0.457 | 18.6 | 0.528 | 21.18 |
| 7 | 13 | 0.330 | 0.635 | 43.9 | 1.182 | 10.82 |
| 8 | 17 | 0.457 | 0.406 | 26.9 | 0.593 | 20.18 |
| 9 | 19 | 0.330 | 0.330 | 29.4 | 0.503 | 13.15 |
| 10 | 19 | 0.635 | 0.457 | 20.1 | 0.511 | 16.72 |
| 11 | 13 | 0.127 | 0.330 | 42.0 | 0.764 | 0.00 |
| 12 | 15 | 0.127 | 0.635 | 45.8 | 1.542 | 0.00 |
| 13 | 19 | 0.127 | 0.457 | 42.6 | 1.079 | 0.09 |
| 14 | 19 | 0.457 | 0.508 | 28.0 | 0.788 | 16.62 |
| 15 | 17 | 0.127 | 0.457 | 44.7 | 1.149 | 0.00 |
| 16 | 14.5 | 0.254 | 0.330 | 40.7 | 0.727 | 9.04 |
| 17 | 19 | 0.127 | 0.635 | 42.0 | 1.514 | 0.00 |
| 18 | 17.5 | 0.508 | 0.584 | 28.4 | 0.942 | 11.54 |
| 19 | 13 | 0.635 | 0.635 | 34.0 | 0.958 | 27.13 |
| 20 | 13 | 0.406 | 0.330 | 26.1 | 0.407 | 28.98 |
| 21 | 13 | 0.635 | 0.635 | 31.4 | 0.733 | 31.06 |
| 22 | 16 | 0.406 | 0.635 | 33.6 | 1.152 | 10.11 |
| 23 | 16 | 0.406 | 0.508 | 30.5 | 0.843 | 18.36 |
| 24 | 17 | 0.635 | 0.508 | 23.2 | 0.629 | 16.90 |
| 25 | 15 | 0.635 | 0.635 | 26.7 | 0.810 | 27.08 |
| 26 | 17 | 0.127 | 0.406 | 43.1 | 1.012 | 0.00 |
| 27 | 13 | 0.127 | 0.330 | 42.4 | 0.775 | 2.36 |
| 28 | 19 | 0.635 | 0.508 | 19.6 | 0.560 | 21.04 |

Each of the characteristics, D, Q, and R, were weighted according to a number of different considerations, including its relative effect on the acceptability of the dispenser assembly to the consumer. The weighting process was iterated sequentially, through trial and error, until minimum values were achieved for samples known to have the best performance. The acceptability of the dispenser assembly to a consumer is given as the “quality” of the dispenser assembly and is represented by the ClarkJValpey (CV) factor—smaller values of CV being more acceptable to consumers than larger ones. We found that, generally, a dispenser assembly having a quality value much greater than about 25 is unacceptable to most consumers. Accordingly, a dispenser assembly according to our invention should have a CV value of at most about 25, where CV=2.5(D−32)+10|Q−1.1|+2.6 R.

At a propellant level of 14.5% by weight and using an actuator cap 16 with a swirl chamber, we found that the body orifice diameter should preferably be between about 0.010″ (0.254 mm) and about 0.025″ (0.635 mm), and more preferably between about 0.010″ (0.254 mm) and about 0.015″ (0.381 mm). The vapor tap diameter should preferably be between about 0.003″ (0.076 mm) and about 0.010″ (0.254 mm), and more preferably between about 0.005″ (0.127 mm) and about 0.008″ (0.203 mm). The at least one stem orifice should preferably have a total area of at least about 0.000628 in² (0.405 mm²), and more preferably at least about 0.000905 in² (0.584 mm²). The exit orifice diameter should preferably be between about 0.013″ (0.330 mm) and about 0.025″ (0.635 mm), and more preferably between about 0.015″ (0.381 mm) and about 0.022″ (0.559 mm). And the dip tube inner diameter should preferably be between about 0.040″ (1.016 mm) and about 0.122″ (3.099 mm), and more preferably between about 0.050″ (1.270 mm) and about 0.090″ (2.286 mm). Not every combination of the above valve orifice dimensions will result in an aerosol dispenser assembly having a quality value of at most 25. However, most aerosol valves of this type having a quality value of at most 25 will have orifice dimensions that fall within the above ranges. Because the performance characteristics are not directly proportional to any one of the critical factors, and because the critical factors are not independent of one another, it is difficult to determine what combination of valve dimensions will result in the optimum quality of the dispensed spray. The tables T.4-T.8 below show how quality changes as the critical factors are varied through a representative range of values around the preferred valve configuration.

TABLE 4
Variation of Body Orifice Diameter

| Vapor | Body | Stem | Dip | Exit | | | | |
|---|---|---|---|---|---|---|---|---|
| Tap | Orifice | Orifice | tube | Orifice | D | Q | R | |
| (mm) | (mm) | (mm²⁾ | (mm) | (mm) | (μm) | (g/s) | (wt. %) | CV |
| 0.127 | 0.330 | 1.824 | 1.524 | 0.457 | 36 | 0.72 | 0.58 | 15 |
| 0.127 | 0.457 | 1.824 | 1.524 | 0.457 | 46 | 1.08 | 0.46 | 36 |
| 0.127 | 0.635 | 1.824 | 1.524 | 0.457 | 48 | 1.17 | 0.54 | 42 |

TABLE 5
Variation of Vapor Tap Diameter

| Vapor | Body | Stem | Dip | Exit | | | | |
|---|---|---|---|---|---|---|---|---|
| Tap | Orifice | Orifice | tube | Orifice | D | Q | R | |
| (mm) | (mm) | (mm²⁾ | (mm) | (mm) | (μm) | (g/s) | (wt. %) | CV |
| 0.127 | 0.330 | 1.824 | 1.524 | 0.457 | 36 | 0.72 | 0.58 | 15 |
| 0.203 | 0.330 | 1.824 | 1.524 | 0.457 | 32 | 0.69 | 11.6 | 34 |
| 0.254 | 0.330 | 1.824 | 1.524 | 0.457 | 31 | 0.68 | 14.7 | 40 |

TABLE 6
Variation of Exit Orifice Diameter

| Vapor | Body | Stem | Dip | Exit | | | | |
|---|---|---|---|---|---|---|---|---|
| Tap | Orifice | Orifice | tube | Orifice | D | Q | R | |
| (mm) | (mm) | (mm²⁾ | (mm) | (mm) | (μm) | (g/s) | (wt. %) | CV |
| 0.127 | 0.330 | 1.824 | 1.524 | 0.330 | 31 | 0.43 | 10.8 | 32 |
| 0.127 | 0.330 | 1.824 | 1.524 | 0.381 | 33 | 0.63 | 5.8 | 22 |
| 0.127 | 0.330 | 1.824 | 1.524 | 0.457 | 36 | 0.72 | 0.58 | 15 |
| 0.127 | 0.330 | 1.824 | 1.524 | 0.559 | 35 | 0.83 | 5.9 | 26 |
| 0.127 | 0.330 | 1.824 | 1.524 | 0.635 | 38 | 1.01 | 17.4 | 61 |

TABLE 7
Variation of Stem Orifice Area

| Vapor | Body | Stem | Dip | Exit | | | R | |
|---|---|---|---|---|---|---|---|---|
| Tap | Orifice | Orifice | tube | Orifice | D | Q | (wt. | |
| (mm) | (mm) | (mm²⁾ | (mm) | (mm) | (μm) | (g/s) | %) | CV |
| 0.127 | 0.330 | 0.405 | 1.524 | 0.457 | <36 | <0.72 | >0.58 | <25 |
| 0.127 | 0.330 | 0.584 | 1.524 | 0.457 | <36 | <0.72 | >0.58 | <25 |
| 0.127 | 0.330 | 1.824 | 1.524 | 0.457 | 36 | 0.72 | 0.58 | 15 |

TABLE 8
Variation of Dip Tube Inner Diameter

| Vapor | Body | Stem | Dip | Exit | | | | |
|---|---|---|---|---|---|---|---|---|
| Tap | Orifice | Orifice | tube | Orifice | D | Q | R | |
| (mm) | (mm) | (mm²⁾ | (mm) | (mm) | (μm) | (g/s) | (wt. %) | CV |
| 0.127 | 0.330 | 1.824 | 1.016 | 0.457 | 34 | 0.71 | 6.9 | 27 |
| 0.127 | 0.330 | 1.824 | 1.270 | 0.457 | 34 | 0.72 | 5.8 | 24 |
| 0.127 | 0.330 | 1.824 | 1.524 | 0.457 | 36 | 0.72 | 0.58 | 15 |
| 0.127 | 0.330 | 1.824 | 2.286 | 0.457 | 35 | 0.76 | 4.2 | 22 |
| 0.127 | 0.330 | 1.824 | 3.099 | 0.457 | 35 | 0.86 | 11.6 | 40 |

From our complete tabular data, we were able to determine which combinations of valve orifice dimensions minimized the value of CV and provided the best performance at a propellant content of 14.5%. In particular, we found that a valve according to a third embodiment, having a body orifice diameter of about 0.013″ (0.330 mm), a vapor tap diameter of about 0.005″ (0.127 mm), an exit orifice diameter of about 0.018″ (0.457 mm), a dip tube inner diameter of about 0.060″ (1.524 mm), and at least one stem orifice having a total area of at least about 0.002827″ (1.824 mm) provided the best performance for an aerosol air freshener. The third embodiment is substantially the same as the first embodiment in many respects, the main differences being the lower possible propellant content and the different ranges of orifice sizes. In this embodiment, A-60 propellant was again used as the propellant, and a swirl chamber mechanical breakup element was employed. Of course, no such mechanical breakup element is required.

The above tables were generated based on experimental data using dispenser assemblies having a propellant content of 14.5%. Gradual increases in propellant content, of course, significantly improve the quality of the dispensed sprays. Thus, by increasing the propellant content slightly, a broader range of valve orifice dimensions become acceptable. That is, a broader range of valve orifice dimensions will achieve an acceptable quality value. For example, simply increasing the propellant content of the preferred embodiment by 2%, the quality value was cut almost in half, from 15.3 to 8.8. We envision that many applications may benefit from using an aerosol dispenser assembly having a propellant content of less than 25% , but greater than the 14.5% achieved by our invention.

We believe it would be possible to produce an aerosol dispenser assembly that requires even less than 14.5% propellant to dispense its contents by employing some of the other factors that were thought to affect the performance characteristics. For example, by providing an even smaller vapor tap, by incorporating some form of mechanical breakup element, by experimenting with different propellant types, by employing different land lengths, and/or by using different materials for construction, we envision being able to achieve satisfactory performance with as little as about 10% propellant content.

Of course, different products, such as paint, deodorant, hair fixatives, and the like, will have different material properties and may, therefore, require different valve orifice sizes. In addition, different products may have different spray characteristics that are acceptable to consumers. Therefore, a different formula for quality may have to be developed for each different product, in order to determine the appropriate valve orifice sizes for that product. We believe, however, that some products, such as insecticides, will have similar physical properties to the aerosol air fresheners upon which our study was based. Accordingly, we would expect such insecticides to have the same or similar formula for quality.

As discussed, in addition to simple methods of designing improved spray dispensers, our invention is directed to a consulting service for designing, or identifying necessary design characteristics, for improved spray dispenser assemblies. The service may include identifying for (or obtaining from) a client preferred performance characteristics for a spray dispenser, aerosol or otherwise. Once the desired performance characteristics are identified, the process involves identifying the factors of the design of the spray assembly that affect those characteristics. As discussed above, it is preferable to determine the primary factors of concern from the numerous possible factors that may affect the design characteristics. This can be determined through institutional knowledge, previously performed (and preferably cataloged studies), and/or experimentation. As in the above-discussed embodiment, when numerous factors are involved, a 2^{k} factorial design may be performed to identify the critical factors of interest.

Once the critical or primary factors are determined, it is preferable to perform a screening design, such as a Box-Behnken design, D-Optimal design, etc., and/or combinations thereof. By performing the same, the number of experiments needed to produce the necessary data can be reduced to a manageable number, and tedious trial and error is avoided. The results of the design screening can be used to identify the preferred combinations of factors that achieve the desired performance characteristics of the spray assembly. Of course, this can be obtained as a ranges of possible combinations that achieve the desired results, or specific values that result the optimization of the performance characteristics.

The consultation client could then be charged for the design specifications necessary to achieve the performance characteristics at issue.

Also, given that many of the experiments performed to provide the necessary data for this process may be repetitive for different analyses, the test date can be compiled in a computer database for later referral. This would reduce the need for continued experimentation over time, and with the consultation business, provide continued additions to the database at a profit, rather than proving a drag on one's own business resources. With the development of a database, some of the steps of the method could be replaced with a step of referring to the previously acquired test data.

Also, we also envision providing, for a fee, software that would allow a client to perform the method on its own. Specifically, our invention encompasses software including code for performing the methods of our invention. Further, with an expanded database, the database could be incorporated into the software to reduce the need for experimentation on the client side.

The embodiments discussed above are representative of preferred embodiments of the present invention and are provided for illustrative purposes only. They are not intended to limit the scope of the invention. Although specific components, configurations, materials, etc., have been shown and described, such are not limiting. For example, various other combinations of valve components, propellant types, propellant pressures, and valve orifice dimensions, can be used without departing from the spirit and scope of our invention, as defined in the claims. In addition, the teachings of the various embodiments may be combined with one another, as appropriate, depending on the desired performance characteristics of the valve.

1. A method of determining design parameters for a design of a spray dispenser assembly for dispensing a mist, the method comprising the steps of:
(a) identifying one or more preferred performance characteristics of the spray dispenser to be designed;
(b) identifying design variables of structures of a spray dispenser assembly that affect the one or more performance characteristics identified in step (a);
(c) obtaining test data indicative of performance characteristics of spray dispensers at different combinations of values of the design variables identified in step (b); and
(d) defining design parameters for the identified design variables, based on the test data from step (c), which defined design parameters provide the one or more preferred performance characteristics when embodied in a spray dispenser.

2. A method according to claim 1, wherein the one or more preferred performance characteristics from step (a) are selected from the group consisting of sprayed particle size, relative span factor, particle concentration, obscuration, spray rate, amount of product remaining in the container at the end of life, plume distance of the spray, cone angle of the spray, fall out of the spray, sound levels of the spray, fill speed, sputter point, stream point and can pressure.

3. A method according to claim 1, wherein the variables in step (b) are selected from the group consisting of dip tube inner diameter, body orifice dimensions, stem orifice diameter, land length, and exit orifice size.

4. A method according to claim 3, wherein the group further consists of propellant content, propellant type, vapor tap diameter, and type of mechanical break-up.

5. A method according to claim 1, wherein step (b) further comprises the sub-steps of (b1) performing a screening design to determine, from a group of possible design variables, primary design variables having an effect on the performance characteristics identified in step (a), and (b2) selecting, based on the results of step (b1), the primary design variables for use as the design variables to be used in step (c).

6. A method according to claim 5, wherein step (b1) includes testing relative effects of the possible design variables on the one or more performance characteristics and performing a screening design on the data obtained from the testing, wherein the primary design variables are selected based on the relative magnitude those design variables have on the one or more performance characteristics.

7. A method according to claim 5, wherein the screening design in sub-step (b1) is a 2^{k} factorial screening design.

8. A method according to claim 5, wherein
(i) the test data obtained in step (c) is achieved through a sampling of experiments,
(ii) step (c) further comprises the sub-step of performing one or more optimization design screenings on the test data achieved through sampling to assess interdependent relationships of the primary design variables at the different combinations of values thereof, and
(iii) the results of the one or more optimization design screenings are used to define the design parameters in step (d).

9. A method according to claim 1, wherein
(i) the test data obtained in step (c) is achieved through a sampling of experiments,
(ii) step (c) further comprises the sub-step of performing one or more optimization design screenings on the test data achieved through sampling to assess interdependent relationships of the design variables at the different combinations of values thereof, and
(iii) the results of the one or more optimization design screenings are used to define the design parameters in step (d).

10. A method according to claim 5, wherein step (d) further comprises the sub-steps of (1) weighting the performance characteristics identified in step (a) according to user preference, and (2) developing a composite product quality factor based on the weighted performance characteristics, which approximates a user's overall satisfaction with a spray dispenser, and (3) selecting the combination of the values of the design variables that provide the preferred performance characteristics based on a quality factor calculated for that combination.

11. A method according to claim 1, wherein step (d) further comprises the sub-steps of (1) weighting the performance characteristics identified in step (a) according to user preference, and (2) developing a composite product quality factor based on the weighted performance characteristics, which approximates a user's overall satisfaction with a spray dispenser, and (3) selecting the combination of the values of the design variables that provide the preferred performance characteristics based on a quality factor calculated for that combination.

12. A method according to claim 1, wherein the test data in step (c) is obtained from a computer database of test data.

13. A method according to claim 1, further comprising the step of designing a spray dispenser assembly based on the design parameters defined in step (d).

14. A method of providing for a client a service of determining design parameters for a design of spray dispenser assembly for dispensing a mist, the method comprising the steps of:
a) determining the client's one or more preferred performance characteristics for the spray dispenser assembly to be designed;
(b) identifying design variables of structures of a spray dispenser assembly that affect the one or more performance characteristics identified in step (a);
(c) obtaining test data indicative of performance characteristics of spray dispensers at different combinations of values of the design variables identified in step (b); and
(d) defining design parameters for the identified design variables, based on the test data from step (c), which defined design parameters provide the one or more preferred performance characteristics when embodied in a spray dispenser.

15. A method according to claim 14, wherein the one or more preferred performance characteristics from step (a) are selected from the group consisting of sprayed particle size, relative span factor, particle concentration, obscuration, spray rate, amount of product remaining in the container at the end of life, plume distance of the spray, cone angle of the spray, fall out of the spray, sound levels of the spray, fill speed, sputter point, stream point, and can pressure.

16. A method according to claim 14, wherein the variables in step (b) are selected from the group consisting of dip tube inner diameter, body orifice dimensions, stem orifice diameter, land length, and exit orifice size.

17. A method according to claim 16, wherein the group further consists of propellant content, propellant type, vapor tap diameter, and type of mechanical break-up means.

18. A method according to claim 16, wherein step (b) further comprises the sub-steps of (b1) performing a screening design to determine, from a group of possible design variables, primary design variables having an effect on the performance characteristics identified in step (a), and (b2) selecting, based on the results of step (b1), the primary design variables for use as the design variables to be used in step (c).

19. A method according to claim 18, wherein step (b1) includes testing relative effects of the possible design variables on the one or more performance characteristics and performing a screening design on the data obtained from the testing, wherein the primary design variables are selected based on the relative magnitude those design variables have on the one or more performance characteristics.

20. A method according to claim 18, wherein the screening design in sub-step (b I) is a 2^{k} factorial screening design.

21. A method according to claim 18, wherein
(i) the test data obtained in step (c) is achieved through a sampling of experiments,
(ii) step (c) further comprises the sub-step of performing one or more optimization design screenings on the test data achieved through sampling to assess interdependent relationships of the primary design variables at the different combinations of values thereof, and
(iii) the results of the one or more optimization design screenings are used to define the design parameters in step (d).

22. A method according to claim 14, wherein
(i) the test data obtained in step (c) is achieved through a sampling of experiments,
(ii) step (c) further comprises the sub-step of performing one or more optimization design screenings on the test data achieved through sampling to assess interdependent relationships of the design variables at the different combinations of values thereof, and
(iii) the results of the one or more optimization design screenings are used to define the design parameters in step (d).

23. A method according to claim 18, wherein step (d) further comprises the sub-steps of (1) weighting the performance characteristics identified in step (a) according to user preference, and (2) developing a composite product quality factor based on the weighted performance characteristics, which approximates a user's overall satisfaction with a spray dispenser, and (3) selecting the combination of the values of the design variables that provide the preferred performance characteristics based on a quality factor calculated for that combination.

24. A method according to claim 14, wherein step (d) further comprises the sub-steps of (1) weighting the performance characteristics identified in step (a) according to user preference, and (2) developing a composite product quality factor based on the weighted performance characteristics, which approximates a user's overall satisfaction with a spray dispenser, and (3) selecting the combination of the values of the design variables that provide the preferred performance characteristics based on a quality factor calculated for that combination.

25. A method according to claim 14, wherein the test data in step (c) is obtained from a computer database of test data.

26. A method according to claim 14, further comprising a step of designing a spray dispenser assembly based on the design parameters defined in step (d).

27. A method according to claim 14, further comprising a step of charging a client for the service.

28. A method of determining design parameters for a design of a spray dispenser assembly for dispensing a mist, the method comprising the steps of:
(a) identifying one or more preferred performance characteristics of the spray dispenser to be designed;
(b) testing design variables of structures of a spray dispenser assembly that affect the one or more performance characteristics identified in step (a), to determine the extent to which variations in a given design variable affect the one or more performance characteristics;
(c) selecting primary design variables based on the determination in step (b);
(d) testing the effects different combinations of the primary design variables have on the one or more performance characteristics in order to determine interdependencies of those primary design variables in affecting the one or more performance characteristics;
(e) defining design parameters for the primary design variables, based on the test data from step (d), which defined design parameters provide the one or more preferred performance characteristics when embodied in a spray dispenser.
